(19) United States
(12) Patent Application Publication
(10) Pub. No.: US 2012/0242174 A1
(43) Pub. Date: Sep. 27, 2012

(54) Hybrid Electro-Magnetic Reciprocating Motor

(76) Inventors: Felix G. C. Wilson, II, Wichita, KS (US); Dennis L. Dreeszen, Denver, CO (US)

(21) Appl. No.: 13/072,712

(22) Filed: Mar. 27, 2011

(51) Int. Cl. H02K 7/075

(52) U.S. Cl. 310/23

(57) ABSTRACT

An electric motor contains a mechanical mechanism that causes a crankshaft to rotate similar to a combustion engine. The mechanical mechanism that creates rotation of the crankshaft may consist of a piston movably mounted in a cylinder in order to rotatingly drive a crankshaft via a connecting rod. The cylinder and the piston conjointly delimit an electro-magnetic chamber. Some embodiments may have one or more electro-magnetic chambers, and may include controllers with feedback sensors to operate the electric motor at a specific speed or to control the speed as defined in a speed profile.

### BACKGROUND

Many different types of rotational electric motors have been developed. These motors include motors that operate using Direct Current (DC) or Alternating Current (AC), and may include constant speed motors and variable speed motors. Additionally, linear motors have been developed that create linear force, rather than rotational torque.

### SUMMARY

An electric motor contains a mechanical mechanism that causes a crankshaft to rotate similar to a combustion engine. The mechanical mechanism that creates rotation of the crankshaft may consist of a piston movably mounted in a cylinder in order to rotatingly drive a crankshaft via a connecting rod. The cylinder and the piston conjointly delimit an electro-magnetic chamber. Some embodiments may have one or more electro-magnetic chambers, and may include controllers with feedback sensors to operate the electric motor at a specific speed or to control the speed as defined in a speed profile.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

In the drawings,

FIG. 1 is a diagram illustration of an embodiment showing an exploded view of an electric motor with an electro-magnetic chamber including a piston and connecting rod, and crankshaft.

FIG. 2 is a diagram illustration of an embodiment showing a plan view of an electric motor with an electro-magnetic chamber including a piston and connecting rod, and crankshaft.

### DETAILED DESCRIPTION

An electric motor may have an internal mechanism that causes rotation of the crankshaft that may consist of a piston movably mounted in a cylinder in order to rotatingly drive the crankshaft via a connecting rod. Disposed around the electro-magnetic chamber may be stators that cause the piston to drive the connecting rod and cause the crankshaft to turn.

The motor may use different types of electrical forcers to cause the motor to turn. The forcers may be constructed as various direct current (DC) and alternating current (AC) forcer types. Some embodiments may use electromagnets or permanent magnets on a forcer component.

The electro-magnetic chamber may comprise a piston and one or more connecting rods which may cause the crankshaft to rotate. The electro-magnetic chamber may have stator forcer components located along the path of the piston. Some embodiments may have the stator forcer components located at the extents of the electro-magnetic chamber.

The piston may be acted upon by an electrical forcer. In an example embodiment illustrated in this specification, a piston is illustrated. The piston may have a piston forcer component of an electrical forcer. Some embodiments may have the stator forcer components located at the extents of the piston travel path. Some embodiments may have the stator forcer components located throughout the travel path of the piston. In such embodiments, the stator forcer components may be segments that apply force during a segment of the piston's travel path. Other embodiments may have stator forcer components and/or piston forcer components that encompass some or all of the piston's travel path.

Some embodiments may have two or more electro-magnetic chambers. In such embodiments, the electro-magnetic chambers may be configured to operate in phase or out of phase or some timing in between.

Throughout this specification, like reference numbers signify the same elements throughout the description of the figures.

When elements are referred to as being “connected” or “coupled,” the elements can be directly connected or coupled together or one or more intervening elements may also be present. In contrast, when elements are referred to as being “directly connected” or “directly coupled,” there are no intervening elements present.

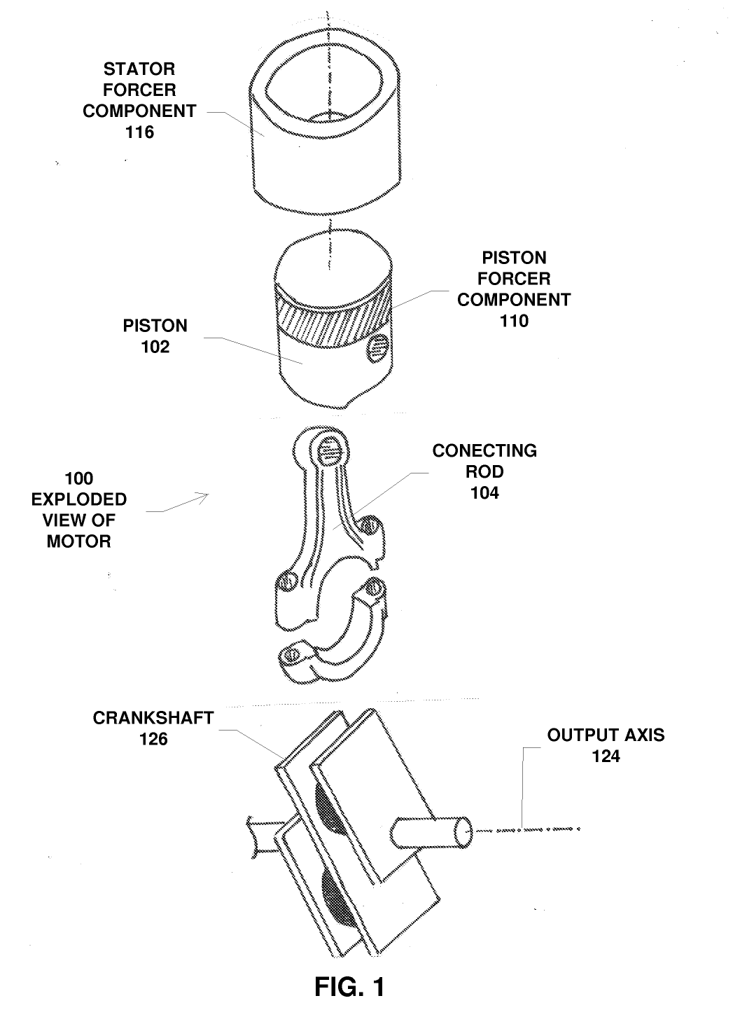

FIG. 1 is a diagram of an embodiment 100 showing an exploded view of an electrical motor with an internal piston and connecting rod mechanism. Embodiment 100 is an example of one embodiment of such an electric motor.

Embodiment 100 illustrates the major components of an electric motor. The components are illustrated in an exploded view in order to show the general shape and configuration of the components. Embodiment 200 presented later in this specification illustrates a plan view showing the configuration of the components shown in embodiment 100 in their assembled positions.

A rotational motion may be created by a mechanism similar to that used in an Otto-cycle combustion engine.

Embodiment 100 illustrates an electric motor that may be powered by a piston forcer element and a stator forcer element. The piston forcer element and stator forcer element may act together to create a translational force that is converted into rotational motion through the use of a connecting rod to the crankshaft.

The piston forcer element and stator forcer element may be any type of mechanism by which electrical energy may be converted to translational or rotational energy. The electrical energy may be either alternating current (AC) or direct current (DC).

The forcer elements use electrical energy to create a force that causes a piston to move. In some embodiments, the forcer elements may operate on a segment of a piston's path.

In one embodiment, a forcer may use AC induction to generate eddy currents in one of the forcer components. The eddy currents may repel a magnetic field generated in the other forcer component, causing the forcer components to move with respect to each other.

In a typical AC induction forcer arrangement, a series of electromagnets may be positioned next to each other and may be powered by different phases of multiphase AC power. Each successive electromagnet may be powered by a different phase of the AC power. When AC power is applied to a first forcer element, the complementary forcer element may be propelled with respect to the first.

In some embodiments, the eddy currents may be generated in a piston forcer component by electromagnets in the stator forcer component. In other embodiments, the piston forcer component may comprise electromagnets which may generate eddy currents in a stator forcer component.

Induction type forcers may use slip to create torque in the motor. Slip may be the difference in speed between the change in the magnetic field and the actual change in position of the forcer components. Without slip, the eddy currents would not be created and no force would be exerted.

When the piston forcer component is supplied with electrical power, a slip ring and brushes may be used to transfer power from a housing to the piston while the piston moves.

AC induction forcers may be controlled using variable frequency drives. A variable frequency drive may change the input frequency of alternating current to the powered forcer component. In some such embodiments, a sensor may detect rotational motion on the crankshaft and generate an output signal that may be used by the variable frequency drive to regulate the speed of the motor.

In some embodiments, AC induction forcers may operate with single phase or two phase AC power. In a two phase embodiment, two different windings may be used to create a variable speed or controllable forcer. Such embodiments may have an AC servo amplifier, such as a linear power amplifier, to control the forcer.

In a single phase embodiment, one or more shading coils may be used in conjunction with a main coil to create a moving magnetic field. The shading coils may be created from a small number of turns, and may be created from a single turn in some cases. In such an embodiment, part of each pole may be encircled by a copper coil or strap and the induced current in the strap may oppose the change of flux through the coil. The change in flux may cause a time lag in the flux passing through the shading coil, so that the maximum field intensity may move across the pole face on each cycle. Such an arrangement may produce a low level moving magnetic field which is large enough to move both the piston and its attached load. As the piston picks up speed, the torque builds up to its full level as the principal magnetic field may be moving relative to the reciprocating piston.

A synchronous AC forcer design may use electromagnets on both piston forcer and stator forcer components to cause motion. One forcer component may be supplied with a DC current to create a constant magnetic field while the other forcer component may be supplied AC current to create attractive or repulsive forces. In some embodiments, AC current may be supplied to both forcer components, and in other embodiments, one forcer component may comprise one or more permanent magnets. Synchronous AC forcer designs typically may have a constant output speed regardless of load.

A DC forcer design may have one forcer component be a set of permanent magnets while the other forcer component is a set of electromagnets that may be switched on and off using a controller. The controller may regulate which electromagnets are energized to create a motive force, and may switch electromagnets on and off to create motion. In some embodiments, the set of permanent magnets may be replaced by electromagnets that may be powered by DC current, and may or may not be varied during operation.

In many AC and DC forcer designs, a feedback sensor may be used to detect the motion of the piston or crankshaft and create an output signal. The output signal may be used by the controller as a feedback sensor to regulate the speed or position of the electric motor.

In some embodiments, the feedback sensor may be a Hall Effect sensor. A Hall Effect sensor may be a transducer that varies output voltage in responses to changes in magnetic fields. In a typical motor embodiment, a magnet may be embedded or attached to a piston or crankshaft, and the Hall Effect sensor may detect each pass of the magnet past the sensor.

In some embodiments, the feedback sensor may be an encoder, such as a linear encoder. A linear encoder may give an output signal that defines the position of the piston as opposed to its speed, which could be determined using a Hall Effect sensor or some other type of sensor.

When a controller is used, a controller may have an input signal that may define a desired speed or position of the motor. In some embodiments, the input signal may define a motion profile that is desired. Such a motion profile may define changes in speed or position over time. The controller may be capable of causing the output of a sensor to follow the input signal to control the motor in a closed loop feedback system.

The number of stator forcer components may be generally the same as or more than the number of electro-magnetic chambers.

The piston 102 is expressed as a cylinder. In many embodiments, the piston 102 may also be comprised of different shapes including, but not limited to a cube shape or a triangular prism.

The electro-magnetic chamber may have multiple forcer components disposed about the piston 102. As illustrated, the piston forcer components 110 are mounted around the perimeter of piston 102. Some embodiments may have piston forcer components offset from the perimeter of the piston by any amount and may cover some or all of the piston's perimeter.

The piston forcer components 110, is illustrated as tubular shaped article through which a piston path may be formed. In some embodiments, the tubular shaped article may be passive, such as when used with induction-type forcer systems. In such cases, a series of electromagnets may be contained in stator forcer component 116 and the excitement of the electromagnets may create eddy currents in the blade shared piston forcer component that is made of a conducting material such as brass, steel, aluminum, copper, or other metal.

In another type of passive piston forcer component, the permanent magnets may be mounted or embedded in the piston forcer component. In some cases, multiple magnets may be positioned in the piston forcer component. When multiple permanent magnets may be used, the magnets may be configured with alternating poles.

In some embodiments, the tubular shaped piston forcer components 110 may be active components. In such embodiments, the piston forcer components may contain one or more coils of wire that may produce magnetic fields when the coils are energized. In some embodiments, the piston forcer component coils may be energized with direct current and in other embodiments, the piston forcer component coils may be energized with alternating current. When direct current is used, the direct current may be constant or switched on and off during motion.

In other embodiments, the piston forcer components may have two or more blades. In such embodiments, the piston forcer components may act with similar shaped stator forcer components. Such embodiments may be useful in cases where higher output torque is desired. The U-shaped stator forcer components and blade shaped piston components as illustrated may be one configuration of a forcer mechanism. Other embodiments may have many different forcer configurations.

In other embodiments, the piston forcer components may be U-shaped in design. In such embodiments, the piston forcer components may act with similar shaped stator forcer components. Such embodiments may be useful in cases where higher output torque is desired. The Tubular-shaped stator forcer components and cylinder-shaped piston forcer components as illustrated may be one configuration of a forcer mechanism. Other embodiments may have many different forcer configurations.

A U-shaped stator component may allow active or passive components to act on both sides of a piston forcer component. In many such embodiments, the U-shaped forcer component may allow higher forces to be applied than a single sided forcer component.

The stator forcer components 116 may be placed on the outer portions of the piston travel path. An example of one embodiment may be shown in embodiment 200 presented later in this specification.

The piston 102 may travel through the electro-magnetic chamber causing the connecting rod 104 to rotate the crankshaft about the rotational axis 124.

A crankshaft 126 may be the mechanism by which the output torque may be transmitted.

In some embodiments, a controller may be used to regulate the speed and/or position of the piston 102 and the crankshaft 126. Torque may be supplied by the actions of the stator forcer components acting on the piston forcer components and causing the piston 102 to travel. A controller may use various feedback mechanisms, such as Hall Effect sensors, encoders, or other mechanisms to sense the actions of the piston 102. In a typical embodiment, the controller may be supplied with an input signal that indicates the desired speed or position of the piston 102, and the controller may use the output signal of a sensor as a feedback loop to cause the piston 102 to match the input signal.

In some embodiments, the controller may not be used and the motor of Embodiment 100 may be run without feedback or in an open loop mode.

Embodiment 100 illustrates a single electro-magnetic chamber embodiment. In some cases, two or more electro-magnetic chambers may be used in an electric motor. When multiple electro-magnetic chambers are used, the various pistons may be configured to be out of phase with respect to each other. Multiple electro-magnetic chamber embodiments may have more power output and smoother operation than single electro-magnetic exiting chamber embodiments in some cases.

In a typical multiple electro-magnetic chamber embodiment, the planes defined by each piston may be parallel to each other, perpendicular to each other or offset at some different angle from each other.

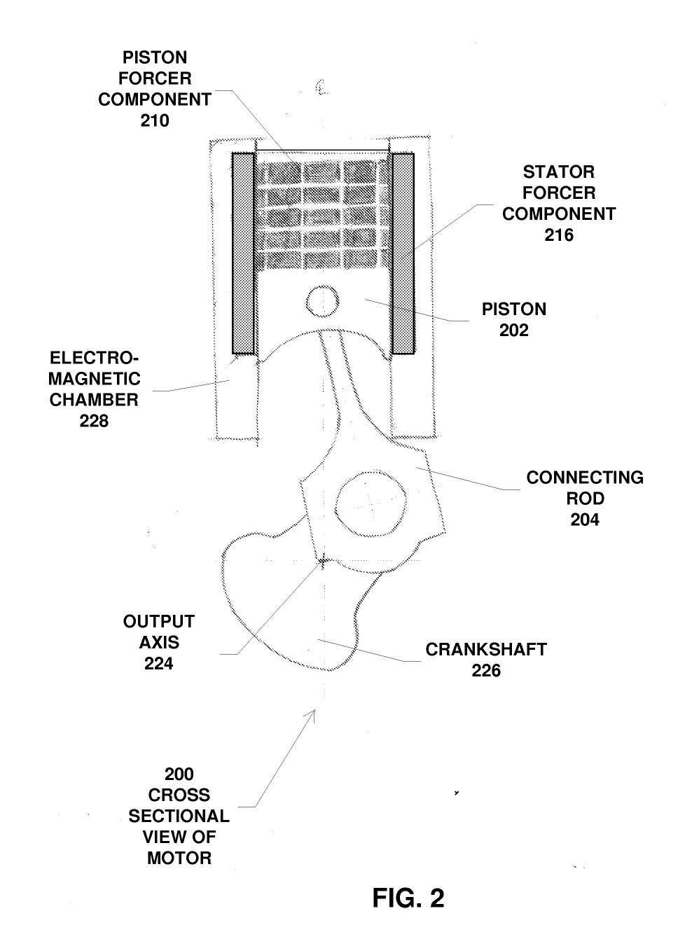

FIG. 2 is a diagram of an embodiment 200 showing a plain view of an electric motor that uses the electro-magnetic chamber and piston/connecting rod mechanism to rotate the crankshaft. Embodiment 200 is an example of a single electro-magnetic chamber electric motor similar to Embodiment 100 presented earlier in this specification. Embodiment 200 illustrates the position of the various components when the motor is assembled.

An electro-magnetic chamber 228 is illustrated with piston forcer components 210 located near the perimeter edges of the piston 202.

Two stator forcer components 216 are illustrated as being positioned at either end of an electro-magnetic chamber 228 that may be traveled by the piston 202. The stator forcer component 216 is illustrated as being cut away and may be a U-shaped stator forcer component such as stator forcer components 116 illustrated in Embodiment 100.

The operation of the electric motor may proceed by the piston forcer component 210 interacting with the stator forcer component 216 to cause the piston 202 to travel. For example, the stator forcer component 216 and piston forcer component 210 may cause the piston 202 to travel through the electro-magnetic chamber. As the piston moves, the mechanism of the connecting rod 204 and crankshaft 226, may cause the piston forcer component 210 to reciprocate to re-engage with the stator forcer component 216, where additional force may be applied to continue moving the piston 210. After the piston forcer component 210 interacts with the stator forcer component 216, the piston forcer component 210 may reciprocate and be in position to engage the stator forcer component 216 and continue the motion.

The piston forcer components 210 are illustrated as being imbedded in the perimeter of the piston 202. As illustrated, the piston forcer components may encompass some or all of the perimeter of the piston. In some embodiments, the piston forcer components may cover less area or may extend beyond the surface area of the piston 202 and engage the piston forcer component for a longer portion of time.

Similarly, the piston forcer component may be added to the upper or lower extents of the piston. In some embodiments, the piston forcer component may act as a solenoid to drive the piston.

Similarly, the stator forcer components 216 illustrated may be imbedded in the perimeter of the electro-magnetic chamber and encompassing some or all of the surface area of the chamber. Some embodiments may have smaller stator forcer components. In some embodiments, the stator forcer components may be much larger and engage a piston forcer component for a longer portion of time.

In some embodiments, the stator forcer components may be placed at the extents of the electro-magnetic chamber.

In some embodiments, the stator forcer components may extend completely around the piston forcer component. In such embodiments, the stator forcer components may be segmented as illustrated or may also be continuous around the piston 202. Some embodiments may have a continuous stator forcer component that completely encircles the piston 202 and may have segmented stator forcer components.

The foregoing description of the subject matter has been presented for purposes of illustration and description. It is not intended to be exhaustive or to limit the subject matter to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments except insofar as limited by the prior art.

What is claimed is:

1. An electric motor comprising:
a housing;
a connecting rod;
a crankshaft;
a piston having a piston forcer component mounted to the piston, said piston connected to said connecting rod, said connecting rod connected to said crankshaft;
a cylinder configured to cause said piston to move in a reciprocating path;
a stator mounted to said housing, said stator comprising stator forcer components mount along reciprocating path;

2. The electric motor of claim 1, said stator forcer component being configured to induce eddy currents in said piston forcer component.

3. The electric motor of claim 2, said piston forcer component having at least one planar face substantially parallel to said electro-magnetic chamber.

4. The electric motor of claim 3, said stator forcer component comprising a U-shaped channel in or around which said piston forcer component passes.

5. The electric motor of claim 3 said stator forcer component comprising a tubular shaped channel in or around which said piston forcer component passes.

6. The electric motor of claim 1, said stator forcer component and said piston forcer component comprising a direct current forcer.

7. The electric motor of claim 1, said stator forcer component and said piston forcer component comprising an alternating current forcer.

8. The electric motor of claim 1, said stator forcer component comprising a plurality of magnets.

9. The electric motor of claim 7, said magnets being electromagnets.

10. The electric motor of claim 1, said piston forcer component comprising a plurality of magnets.

11. The electric motor of claim 9, said magnets being electromagnets.

12. The electric motor of claim 1, said piston forcer component further comprising a slip ring.

13. The electric motor of claim 1 further comprising:
a sensor configured to determine rotational movement of said electric motor and produce an output signal; and
a controller configured to receive said output signal and control said electric motor in response to an input signal.

14. The electric motor of claim 13, said sensor being mounted to detect directional movement of said piston.

15. The electric motor of claim 13, said sensor being mounted to detect rotational movement of said crankshaft.

16. The electric motor of claim 13, said sensor being a Hall Effect sensor.

17. The electric motor of claim 13, said input signal defining a rotational speed.

18. The electric motor of claim 13, said input signal defining a rotational position.

19. An electric motor comprising:
a housing;
a connecting rod;
a crankshaft;
a piston having a piston forcer component mounted to the piston, said piston connected to said connecting rod, said connecting rod connected to said crankshaft;
a cylinder configured to cause said piston to move in a reciprocating path;
a stator mounted to said housing, said stator comprising stator forcer components mount along reciprocating path;

20. The electric motor of claim 19 further comprising:
a second piston, said piston having said piston forcer component mounted to said piston, said second piston having a second cylinder and a second reciprocating travel path;
said second piston being positioned within said housing such that said second reciprocating travel path is parallel to said first reciprocating travel path and said first piston is parallel to and offset from said second piston.
